(19) United States
(12) Patent Application Publication
(10) Pub. No.: US 2026/0213249 A1
(43) Pub. Date: Jul. 23, 2026

(54) SEPARATOR SLIP PREVENTION IN A BATTERY CELL DURING BATTERY CELL TRAVEL

(71) Applicant: LG ENERGY SOLUTION, LTD., Seoul (KR)

(72) Inventor: Gabhyung KIM, Troy, MI (US)

(21) Appl. No.: 19/035,657

(22) Filed: Jan. 23, 2025

(51) Int. Cl. H01M 10/04

(52) U.S. Cl. CPC H01M 10/0431; H01M 10/0409

(57) ABSTRACT

A method of preventing separator slip in a battery cell that is stopped by a stopper in a production line, the method includes transporting the battery cell in a length-wise direction at the production line such that terminal tabs of the battery cell are parallel to a moving direction of the production line, and controlling an acceleration of the battery cell to move on the production line to less than 7G such that the separator slip is prevented in an impact between the battery cell and the stopper.

### TECHNICAL FIELD

The present disclosure relates to preventing a separator slip in a battery cell during battery cell travel, and in particular, during battery cell travel in a production line.

### BACKGROUND

Due to their characteristics of being able to store and discharge electrical energy many times over the course of its life, secondary batteries are sources of energy for electric vehicles (EVs) or hybrid electric vehicles (HEVs) and the like. Secondary batteries are also storage source of energy in energy storage systems (ESSs) and the like. One goal of secondary batteries is to reduce the use of fossil fuels in motor vehicles that pollute the environment and generate greenhouse gases. In addition, secondary batteries can be used as storage source of energy in a renewable energy source infrastructure providing for eco-friendly and energy efficient source of energy.

Generally, a secondary battery starts with a battery cell, which typically has an operating voltage of about 2.5V to 4.5V. Since a higher output voltage may be required to be practical, a plurality of battery cells may be stacked and connected together. Additionally, a plurality of stacked battery cells may be connected to form a battery pack or a battery rack according to the required charge/discharge capacity. A battery pack is typically used in EVs and HEVs, and a battery rack is typically used in ESSs. Accordingly, the number of battery cells included in the battery pack or the battery rack may be variously set depending on the required output voltage and/or charge/discharge capacity.

Each of the battery cells may be, but is not limited to, a pouch, cylindrical, or prismatic-shaped battery cell. For example, the pouch-shaped battery cell may have a soft aluminum-coated plastic or aluminum foil pouch configured to receive an electrode assembly with two conductive terminal tabs protruding out from a side of the pouch in the length-wise direction. The two conductive terminal tabs may protrude out in the same direction, or one of the conductive terminal tab may protrude out in a direction opposite to the other terminal tab.

On the other hand, the cylindrical or prismatic battery cell includes a metal cell case configured to receive an electrode assembly, the metal cell case being electrically connected to a negative electrode lead of the electrode assembly, and a top cap located on top of the cell case. The top cap is not electrically connected to the cell case due to an insulating member, and is electrically connected to a positive electrode lead of the electrode assembly, whereby the top cap acts as a positive electrode terminal, which may protrude farther than the upper surface of the cell case.

The electrode assembly includes a cell assembly and leads, and the cell assembly may be a jelly-roll type cell assembly, which is configured to have a structure in which a long sheet type positive electrode and a long sheet type negative electrode are wound in the state in which a separator is interposed therebetween. The cell assembly may be a stacked type cell assembly including unit cells, each of which is configured to have a structure in which a rectangular positive electrode and a rectangular negative electrode are stacked in the state in which a separator is interposed therebetween. The cell assembly may be a stacked and folded type cell assembly, which is configured to have a structure in which unit cells are long positive and negative films, with a long separation film therebetween, which are folded and stacked. It should be noted that the above are just examples, and the present disclosure is not limited thereto.

In a pair of leads constituted by a positive electrode lead and a negative electrode lead, in the case of the pouch-shaped battery cell, the positive electrode lead and the negative electrode lead may be directly or indirectly connected to the respective terminal tabs. In the case of the cylindrical or prismatic battery cell, the positive electrode lead may be directly and indirectly connected to the positive electrode of the cell assembly and the top cap, and the negative electrode lead may be electrically connected to the cell case. The electrode assembly constituting a pouch, cylindrical, or prismatic-shaped battery cell is generally well known, and therefore further description is not further provided.

### SUMMARY

The present disclosure aims to prevent a separator slip in a battery cell during battery cell travel in a production line and stopped by a stopper. An occurrence of a separator slip may be where a terminal tab has been pushed into the battery cell resulting in at least a portion of the separator being slipped from its proper position.

To solve the separator slip problem, the present disclosure provides a method of preventing separator slip in a battery cell that is stopped by a stopper in a production line, the method comprising transporting the battery cell in a length-wise direction at the production line such that terminal tabs of the battery cell are parallel to a moving direction of the production line; and controlling an acceleration of the battery cell to move on the production line to less than 7G such that the separator slip is prevented in an impact between the battery cell and the stopper.

The acceleration of the battery cell to move on the production line may be no more than 6.8G.

The method may comprise controlling a speed of the battery cell such that the speed does not exceed 610mm/sec at impact with the stopper.

The method may comprise controlling a speed of the battery cell such that the speed does not exceed 526mm/sec at impact with the stopper.

In transferring the battery cell to another production line, the method may comprise transporting the battery cell in a width-wise direction at the another production line such that terminal tabs of the battery cell are orthogonal to a moving direction of the another production line.

In another aspect, a method of preventing separator slip in a battery cell that is stopped by a stopper in a production line may comprise transporting the battery cell in a width-wise direction at the production line such that terminal tabs of the battery cell are orthogonal to a moving direction of the production line; transferring the battery cell to another production line such that the battery cell travels in a length-wise direction in which the terminal tabs of the battery cell are parallel to a moving direction of the another production line; and controlling an acceleration of the battery cell to move on the another production line to less than 7G such that the separator slip is prevented in an impact between the battery cell and the stopper.

The acceleration of the battery cell to move on the another production line may be no more than 6.8G.

The method may comprise controlling a speed of the battery cell traveling at the another production line such that the speed does not exceed 610mm/sec at impact with the stopper.

The method may comprise controlling a speed of the battery cell traveling at the another production line such that the speed does not exceed 526mm/sec at impact with the stopper.

In yet another aspect, a method of preventing separator slip in a battery cell that is stopped by a stopper in a production line may comprise transporting the battery cell in a width-wise direction at the production line such that terminal tabs of the battery cell are orthogonal to a moving direction of the production line; and transferring the battery cell to another production line such that the battery cell travels in the width-wise direction in which the terminal tabs of the battery cell are orthogonal to a moving direction of the another production line.

The method may comprise rotating the battery cell at transfer to another production line such that the battery cell travels in the width-wise direction.

In the case where the another production line is orthogonal to the production line, the method may comprise rotating the battery cell 90 degrees at transfer to the another production line such that the battery cell travels in the width-wise direction at the another production line.

Accordingly, separator slip in a battery cell may be prevented and productivity may be increased. Also, problems regarding low voltage defect may be eliminated, and a potential short circuit between the positive electrode and the negative electrode of the battery cell that could result in the battery cell catching fire or exploding may also be prevented.

In addition, the present disclosure may have various other effects, and these will be described in the respective embodiments, or description of effects that may be easily inferred by those skilled in the art will be omitted.

### BRIEF DESCRIPTION OF THE DRAWINGS

The accompanying drawings illustrate an exemplary embodiment of the present disclosure and together with the following detailed description, serve to provide further understanding of the technical features of the present disclosure, and thus the present disclosure is not construed as being limited to the drawings.

FIG. 1A is a diagram illustrating an exemplary pouch-shaped battery cell; and FIG. 1B is a diagram illustrating the exemplary pouch-shaped battery cell in which a separator slip has occurred.

FIG. 2 is a diagram illustrating a pallet on which a pouch-shaped battery cell may travel along a production line.

FIG. 3A is a diagram illustrating a pouch-shaped battery cell on a pallet for traveling on a production line; and FIG. 3B is a diagram illustrating the pouch-shaped battery cell on the pallet stopped by a stopper at the production line.

FIG. 4A is a diagram illustrating impact measurement of a pouch-shaped battery cell on a pallet stopped by a stopper; FIG. 4B is a diagram illustrating impact measurement data; and FIG. 4C is a diagram illustrating the pouch-shaped battery cell in which a separator slip has occurred.

FIG. 5 is a diagram illustrating an acceleration graph of a pouch-shaped battery cell on a pallet moving on a production line.

FIGS. 6A is a diagram illustrating an acceleration measurement value based on a range setting; and FIG. 6B is a diagram illustrating whether separator slip occurred based on various range settings.

FIG. 7 is a diagram illustrating an impact value based on various range setting.

FIG. 8A is a diagram illustrating a pouch-shaped battery cell on a pallet moving on a production line in the length-wise direction; and FIG. 8B is a diagram illustrating the pouch-shaped battery cell on the pallet moving on the production line in the width-wise direction.

FIG. 9 is a diagram illustrating pouch-shaped battery cells moving in production lines according to an embodiment of the present disclosure.

FIG. 10 is a diagram illustrating pouch-shaped battery cells moving in productions lines according to another embodiment of the present disclosure.

FIG. 11 is a diagram illustrating pouch-shaped battery cells moving in productions lines according to yet another embodiment of the present disclosure.

### DETAILED DESCRIPTION

The present disclosure may be variously changed and have various aspects, and the specific aspects disclosed herein in detail are used to facilitate an understanding of the present disclosure to those skilled in the art.

Therefore, it should be understood that there is no intention to limit the present disclosure to the particular aspects disclosed, and on the contrary, the present disclosure covers all modifications, equivalents, and alternatives falling within the spirit and scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

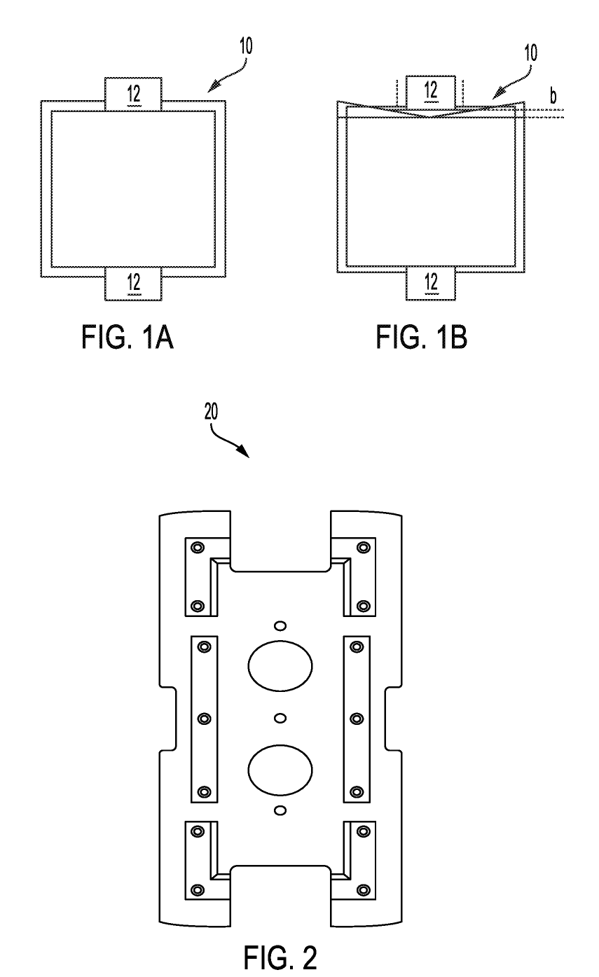

FIG. 1A is a diagram illustrating an exemplary pouch-shaped battery cell 10; and FIG. 1B is a diagram illustrating the exemplary pouch-shaped battery cell 10 in which a separator slip has occurred. Referring to FIG. 1A, the pouch-shaped battery cell 10 may have a soft aluminum-coated plastic or aluminum foil pouch configured to receive an electrode assembly. The pouch may be filled with a liquid electrolyte or a solid electrolyte. The electrode assembly may be a jelly roll or a stacked layer of a positive electrode and a negative electrode with a separator therebetween. The positive electrode and the negative electrode may be connected to respective terminal tabs 12 which protrude from the pouch-shaped battery cell 10 to be connected to another pouch-shaped battery cell or external circuits. The pouch-shaped battery cell 10 shown in FIG. 1A has a terminal tab 12 that protrudes out from one side of the pouch-shaped battery cell 10 and the other terminal tab 12 that protrudes out from the opposite side of the pouch-shaped battery cell 10 in the length-wise direction. However, the pouch-shaped battery cell is not limited thereto and may have both terminal tabs protruding out from the same side of the pouch-shaped battery cell in the length-wise direction, for example.

FIG. 1B illustrates the exemplary pouch-shaped battery cell 10 in which a separator slip has occurred. As shown in FIG. 1B, the lead terminal tab 12 has been pushed into the pouch of the pouch-shaped battery cell 10 by a distance b resulting in at least a portion of the separator being slipped from its proper position. The outermost portion of the separator being pushed inward from its original position may result in the pouch-shaped battery cell not being able to charge or discharge to its full voltage potential resulting in the occurrence of low voltage defect. In the worst case scenario, the separator slip may result in a potential short circuit between the positive electrode and the negative electrode that could result in the pouch-shape battery cell 10 catching fire or exploding. One cause of the outermost portion of the separator to be pushed inward may be caused by impact to the lead terminal tab 12 as the pouch-shaped battery cell 10 travels from one station to another station in a production line. The lead terminal tab 12 being at the head of the pouch-shaped battery cell 10 during travel may collide with an object during a stop at a station. For example, the object may be a stopper at the station or a closed end of a pallet on which the pouch-shaped battery cell 10 is traveling.

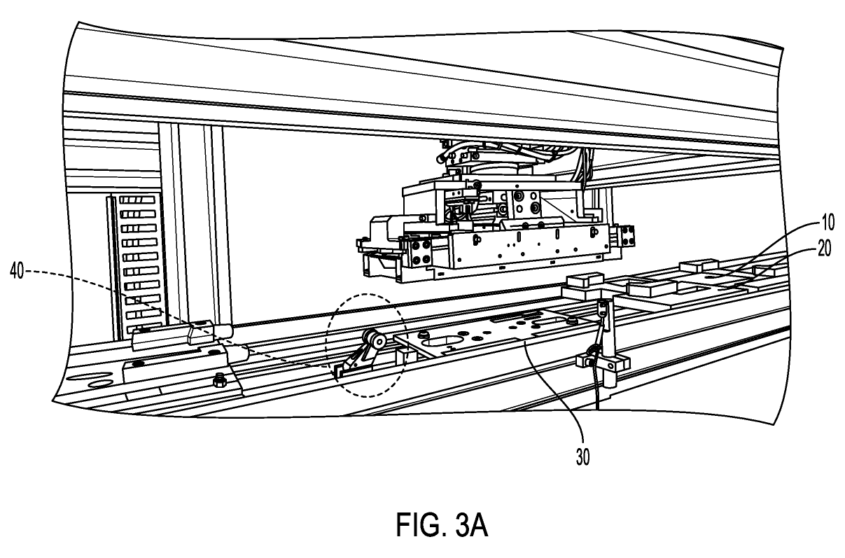

FIG. 2 is a diagram illustrating a pallet 20 on which a pouch-shaped battery cell may travel along a production line. The pallet 20 shown in FIG. 2 is designed to accommodate two pouch-shaped battery cells front and back along the length of the pallet. However, the pallet is not limited to the configuration shown in FIG. 2, and may be configured to accommodate a single pouch-shaped battery cell or more than two pouch-shaped battery cells along the length of the pallet. In various cases, two or more pouch-shaped battery cells may be stacked on top of each other on the pallet 20. The stacked battery cells may then be bind together for ease of handling when placing in a pack or rack, for example. The pallet 20 shown in FIG. 2 has a center portion on either end that is opened to accommodate a terminal tab of a pouch-shaped battery or batteries. However, in other cases, unlike that shown in FIG. 2, the pallet may not have a center portion that is opened, and thereby the ends of the pallet are closed enclosing the pouch-shaped battery or batteries including the terminal tabs in the pallet. In those pallets, the lead terminal tab of pouch-shaped battery may collide with an end of the pallet due to momentum of the pouch-shaped battery when the pallet enters a station and is stopped by a stopper.

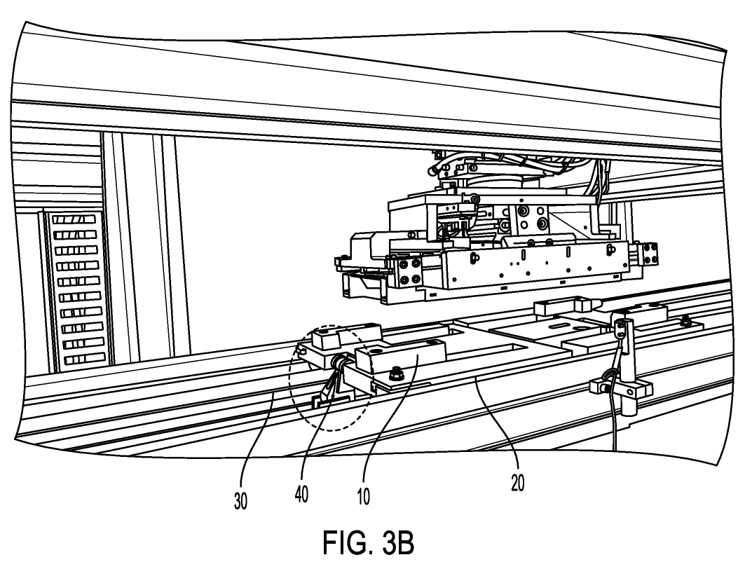

FIG. 3A is a diagram illustrating a pouch-shaped battery cell 10 on a pallet 20 for traveling on a production line 30; and FIG. 3B is a diagram illustrating the pouch-shaped battery cell 10 on the pallet 20 stopped by a stopper 40 at the production line 30. Stoppers in a production line are well known and will not be further described. In FIG. 3A, the pallet 20 carries two pouch-shaped battery cells 10 and may travel toward a station at a constant speed. In FIG. 3B, when the pallet 20 reaches the station, the pallet 20 is stopped by the stopper 40 at the station, whereby the speed of the pallet 20 decelerates from a constant speed to zero speed. During this time, the lead terminal tab of the lead pouch-shaped battery cell 10 may bump into the stopper 40 through the open center portion at the end of the pallet 20. In the case the end of the pallet is close ended, the lead terminal tab of the lead pouch-shaped battery cell may bump into the end of the pallet. Also, it may be possible that the two pouch-shaped battery cells may bump into one another. It has been determined that the separator slip may occur during this time, and therefore a speed boundary needs to be investigated according to the battery cell impact speed in which a separator slip does not occur.

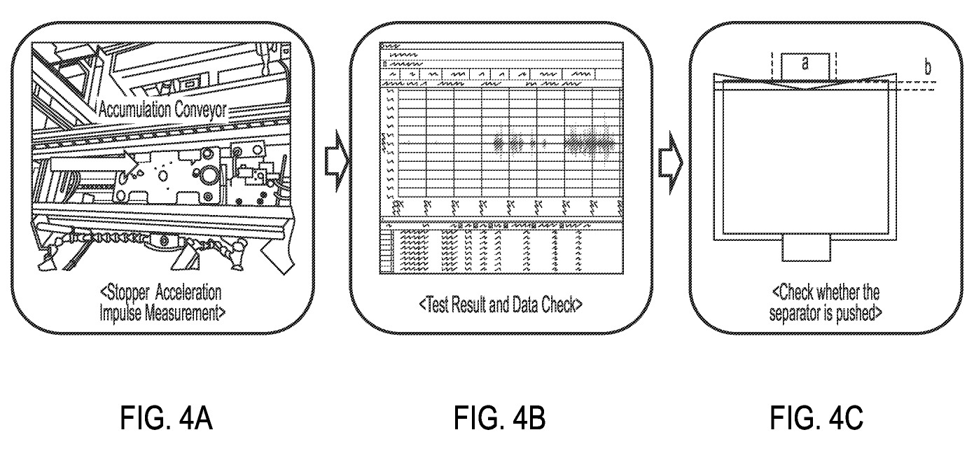

FIG. 4A is a diagram illustrating impact speed measurement of a pouch-shaped battery cell on a pallet stopped by a stopper; FIG. 4B is a diagram illustrating impact measurement data; and FIG. 4C is a diagram illustrating the pouch-shaped battery cell in which a separator slip has occurred.

Referring to FIG. 4A, an accelerometer is placed on the pouch-shaped battery cell to measure speed of the pouch-shaped battery cell (i.e., the pallet) until stopped by the stopper. The pouch-shaped battery cell is made to travel towards the stopper and the speed of the pouch-shaped battery cell at set intervals until impact with the stopper is measured by the accelerometer. As the accelerometer measures in “G”, which is a unit of acceleration, a relative speed of the pallet may be determined. Thus, to determine the actual speed corresponding to the measured G of the pallet, the distance in which the pallet travels over time is measured and the speed calculated. For example, referring to FIG. 3B, the time in which the pallet travels one pallet length prior to being stopped by the stopper may be measured. Based on the pallet length and the measured time, the speed corresponding the G value measured by the accelerometer prior to being stopped by the stopper may be determined. It should be noted that this is just one way of measuring speed, and other methods for measuring speed may be used.

The pouch-shaped battery cell is made to travel at various speeds to determine a speed boundary in which the separator slip does not occur. FIG. 4B illustrates readings from the accelerometer as the pouch-shaped battery cell travels towards the stopper and is ultimately stopped by the stopper. The moving speed of the pouch-shaped battery cell may be determined to reconcile with the separator slip, and thereby a speed boundary determined in which the separator slip is prevented. With each test, the pouch-shaped battery cell is checked to determine whether a separator slip has occurred. FIG. 4C shows a pouch-shaped battery cell in which a separator slip has occurred. A test for reproducing separator slip according to battery cell moving speed at impact will now be further described.

Referring back to FIG. 3A, a pouch-shaped battery cell having an accelerometer placed thereon on a pallet is placed on the production line at a reference point, which is a distance away from the stopper. In this instance, the reference point may be a length of the pallet away from the stopper. However, the reference point may be any point suitable for testing a speed boundary. The pallet is then accelerated until the pallet is traveling at a test speed (test G value). The pallet is then stopped by the stopper as shown in FIG. 3B, at which the pallet decelerates to zero speed. The pouch-shaped battery cell is then checked for separator slip, for example, as shown in FIG. 4C.

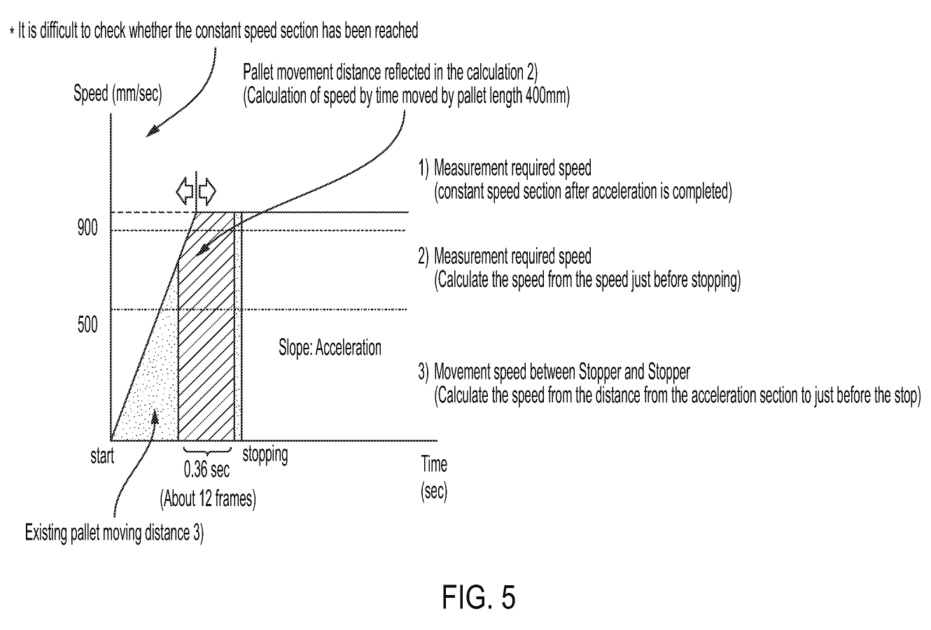

FIG. 5 is a diagram illustrating an acceleration graph of a pouch-shaped battery cell on a pallet moving on a production line. Referring to the acceleration graph on FIG. 5, a pouch-shaped battery cell having an accelerometer placed thereon on a pallet is accelerated to a test speed (test G value). Once the test speed is reached, the speed at which the pallet travels is maintained at a constant test speed. The accelerometer sends the measured G value of the pallet at set intervals from the time the pallet is first accelerated. The set interval may be set on the accelerometer by the user. Based on the G value of the moving pallet sent by the accelerometer at set intervals, the acceleration graph of FIG. 5 may be generated. The acceleration graph shows speed over time. The speed may be calculated at the set intervals in which the accelerometer sends the measured G value based on the distance in which the pallet traveled over time. It should be noted that because the speed of the pallet is determined at set intervals, it may be difficult to determine when exactly the section in which the constant speed is to be maintained has been reached. Nevertheless, it may be irrelevant as the speed that is relevant for purposes of the separator slip is the speed just before the pallet is stopped by the stopper (impact speed). From the acceleration graph of FIG. 5, the test speed just before the pallet is stopped by the stopper may be determined.

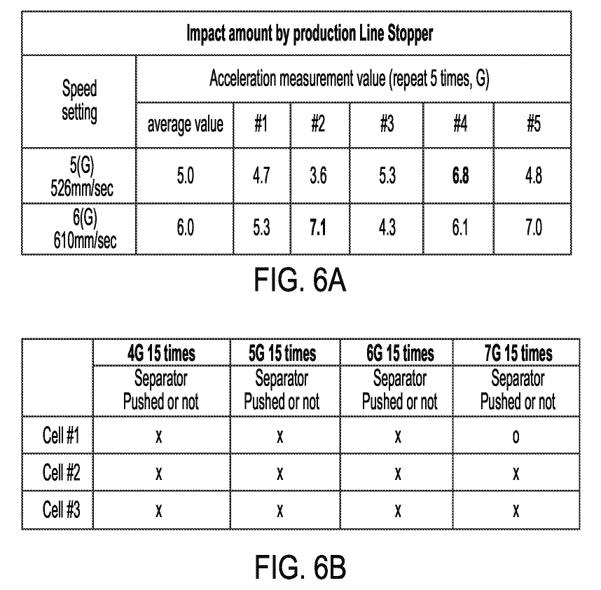

FIGS. 6A is a diagram illustrating an acceleration measurement value based on a speed setting; and FIG. 6B is a diagram illustrating whether separator slip occurred based on various speed settings. Referring to FIG. 6A, a test speed of 5G (526mm/sec) and 6G (610mm/sec) were performed on the pouch-shaped battery cell having an accelerometer placed thereon on a pallet and accelerated on a production line. For each test speed, the test was performed five times. FIG. 6A shows the measured values by the accelerometer repeated five times at test speed of 5G (526mm/sec) and 6G (610mm/sec). It is noted that on the fourth test at 5G, a value of 6.8G was measured by accelerometer. Also, on the third test at 6G, a value of 7.1G was measured by the accelerometer, and on the fifth test at 6G, a value of 7.0G was measured by the accelerometer.

Referring to FIG. 6B, a test speed of 4G, 5G, 6G, and 7G were performed on three different pouch-shaped battery cells. For each test, the test was performed fifteen times. Then, whether a separator slip had occurred on the pouch-shaped battery cell was checked. As shown in FIG. 6B, a separator slip occurred on the first pouch-shaped battery cell at 7G in which the test was performed fifteen times. However, no separator slip occurred at test speed of 4G, 5G, and 6G.

Based on the above, a separator slip did not occur at an impact speed under 7G. In 5G (526 mm/sec) test condition, a measured value of 6.8G was obtained, however this is below the critical impact speed of 7G. In 6G (610mm/sec) test condition, a measured value of 7.1G was obtained, which was above the critical impact speed of 7G. Tests showed that in 5G and 6G, separator slip did not occur, however, in 6G condition, there was a value (7.1G) that was above the critical impact speed of 7G.

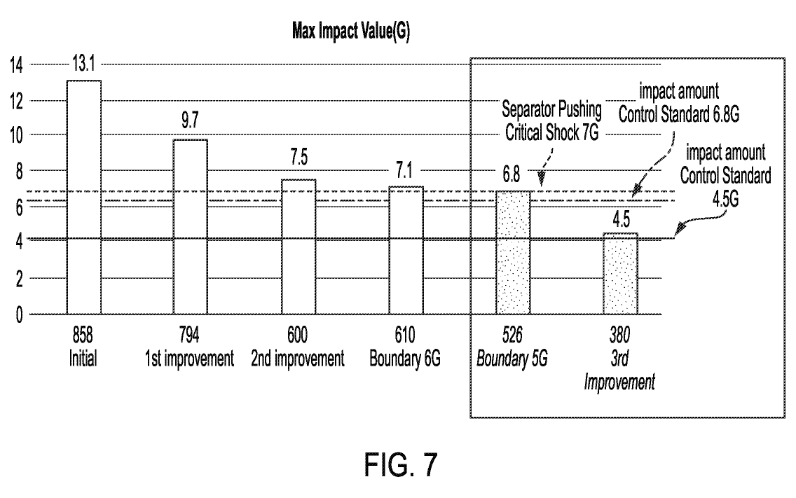

FIG. 7 is a diagram illustrating an impact value based on various speed setting. Referring to FIG. 7, a pouch-shaped battery cell on a pallet moving on a production line at 858mm/sec was initially conceived. However, this travel speed resulted in a maximum impact value of 13.1G, and also separator slip occurring the pouch-shaped battery cell. An improvement was made to reduce the travel speed to 794mm/sec, which resulted in a maximum impact value of 9.7G, Here also, separator slip occurred in the pouch-shaped battery cell. Another improvement was made to reduce the travel speed to 600mm/sec, which resulted in a maximum impact value of 7.5G. However, here also, separator slip occurred in the pouch-shaped battery cell. Yet, another improvement was made to reduce the travel speed to 380mm/sec, which result in a maximum impact value of 4.5G. Here, no separator slip occurred in the pouch-shaped battery cell.

Tests were performed between 380mm/sec(4G), 526mm/sec(5G), and 610mm/sec(6G). As shown in FIGS. 6A and 6B, no separator slip occurred at 380mm/sec(4G), 526mm/sec(5G), and 610mm/sec(6G). However, in the travel speed of 610mm/sec(6G), a maximum value of 7.1G impact speed did occur. Referring to FIG. 6B, it was found that while a travel speed of 4G, 5G, and 6G did not result in a separator slip in the pouch-shaped battery cell, at 7G, separator slip did occur. Based on the test results above, a speed boundary of up to 6.8G or 526mm/sec travel speed was concluded. It should be noted that, at 7G, separator slip did occur, and thus, a speed boundary below 7G should be set.

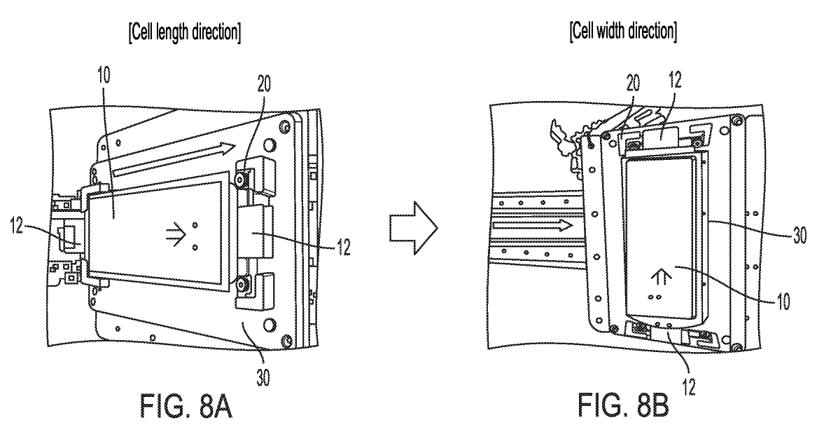

FIG. 8A is a diagram illustrating a pouch-shaped battery cell 10 on a pallet 20 moving on a production line 30 in the length-wise direction; and FIG. 8B is a diagram illustrating the pouch-shaped battery cell 10 on the pallet 20 moving on the production line 30 in the width-wise direction. Referring to FIG. 8A, a pouch-shaped battery cell 10 on a pallet 20 moving on a production line 30 in the length-wise direction leaves the lead terminal tab 12 of the pouch-shaped battery cell 10 vulnerable to being pushed inward into the pouch-shaped battery cell 10 resulting in a separator slip. For example, the lead terminal tab 12 of the lead pouch-shaped battery cell 10 may bump into the stopper through the open center portion at the end of the pallet 20. In the case the end of the pallet is close ended, the lead terminal tab of the lead pouch-shaped battery cell may bump into the end of the pallet. Also, it may be possible that the lead terminal tab of the pouch-shaped battery cell may bump into another pouch-shaped battery cell. Referring to FIG. 8B, a pouch-shaped battery cell 10 on a pallet 20 moving on a production line 30 in the width-wise direction has its side in the traveling direction and the terminal tabs 12 protruding orthogonal to the traveling direction. A pouch-shaped battery cell 10 on a pallet 20 moving on a production line 30 in the width-wise direction has its terminal tabs 12 protected against an impact with the stopper, end of the pallet, or another pouch-shaped battery cell. Thereby, the terminal tab(s) 12 of the pouch-shaped battery cell 10 are protected against being pushed inward into the pouch-shaped battery cell 10 resulting in a separator slip.

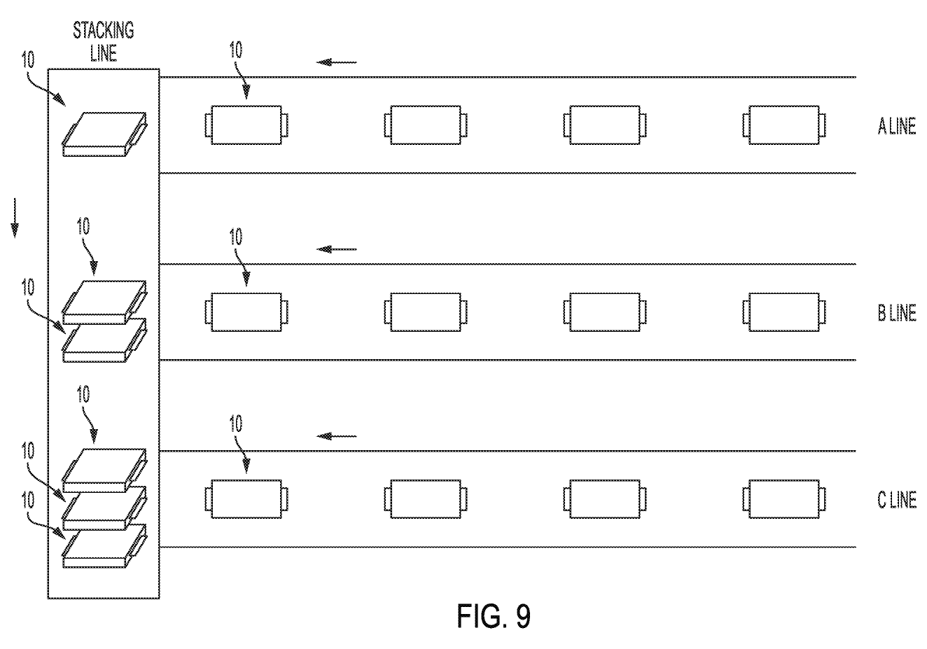

FIG. 9 is a diagram illustrating pouch-shaped battery cells 10 moving in production lines according to an embodiment of the present disclosure. Referring to FIG. 9, the production lines comprise transfer lines A Line, B Line, C Line, and Stacking Line. A pouch-shaped battery cell 10 traveling in the A Line is transferred to the Stacking line. The A Line moves the pouch-shaped battery cell 10 in a length-wise direction and is configured to move the pouch-shaped battery cell 10 in a speed boundary of below 7G, and preferably in a speed range greater than zero and up to 526mm/sec or 610mm/sec. Alternatively, the A Line is configured to move the pouch-shaped battery cell 10 in a length-wise direction and is configured to move the pouch-shaped battery cell 10 such that the maximum impact value that the lead terminal tab of the pouch-shaped battery cell encounters is no more than 6.8G. At the end of the A Line, the pouch-shaped battery cell 10 is transferred to the Stacking Line where the pouch-shaped battery cell 10 travels along the Stacking Line in the width-wise direction.

At the B Line, the pouch-shaped battery cell 10 travels in a length-wise direction and the B Line is configured to move the pouch-shaped battery cell 10 in a speed boundary of below 7G, and preferably in a speed range greater than zero and up to 526mm/sec or 610mm/sec. Alternatively, the B Line is configured to move the pouch-shaped battery cell 10 in a length-wise direction and is configured to move the pouch-shaped battery cell such that the maximum impact value that the lead terminal tab of the pouch-shaped battery cell encounters is no more than 6.8G. At the end of the B Line, the pouch-shaped battery cell 10 is transferred to the Stacking line where the pouch-shaped battery cell 10 meets with the pouch-shaped battery cell 10 from the A Line and traveling along the Stacking Line. The pouch-shaped battery cell 10 from the B Line is stacked on the pouch-shaped battery cell 10 from the A Line, and the stacked pouch-shaped battery cells both travel on the Stacking Line in the width-wise direction.

At the C Line, the pouch-shaped battery cell 10 travels in a length-wise direction and the C Line is configured to move the pouch-shaped battery cell 10 in a speed boundary range of below 7G, and preferably in a speed range greater than zero and up to 526mm/sec or 610mm/sec. Alternatively, the C Line is configured to move the pouch-shaped battery cell 10 in a length-wise direction and is configured to move the pouch-shaped battery cell such that the maximum impact value that the lead terminal tab of the pouch-shaped battery cell 10 encounters is no more than 6.8G. At the end of the C Line, the pouch-shaped battery cell 10 is transferred to the Stacking Line where the pouch-shaped battery cell 10 meets with the stacked pouch-shaped battery cells from the A Line and the B Line, and traveling along the Stacking Line. The pouch-shaped battery cell 10 from the C Line is stacked on the stacked pouch-shaped battery cells, and the three stacked pouch-shaped battery cells travel on the Stacking Line in the width-wise direction where subsequently, the three stacked pouch-shaped battery cells are bound to each other.

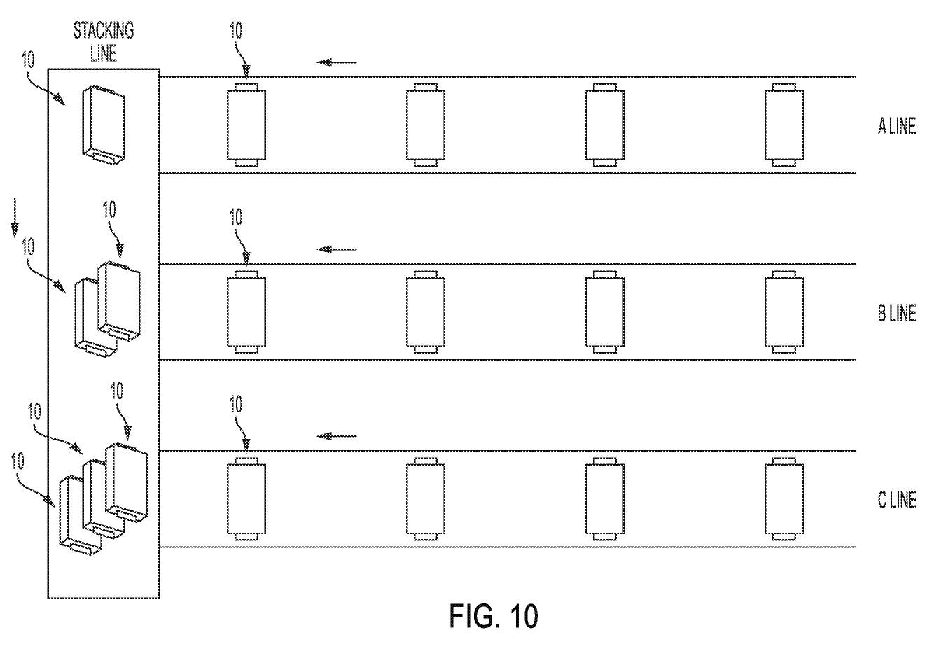

FIG. 10 is a diagram illustrating pouch-shaped battery cells 10 moving in productions lines according to another embodiment of the present disclosure. Referring to FIG. 9, the production lines comprise transfer lines A Line, B Line, C Line, and Stacking Line. A pouch-shaped battery cell 10 traveling in the A Line is transferred to the Stacking line. The A Line moves the pouch-shaped battery cell 10 in a width-wise direction. At the end of the A Line, the pouch-shaped battery cell is transferred to the Stacking Line where the pouch-shaped battery cell 10 travels along the Stacking Line in the length-wise direction. The Stacking Line is configured to move the pouch-shaped battery cell 10 in a speed boundary of below 7G, and preferably in a speed range greater than zero and up to 526mm/sec or 610mm/sec. Alternatively, the Stacking Line is configured to move the pouch-shaped battery cell 10 such that the maximum impact value that the lead terminal tab of the pouch-shaped battery cell encounters is no more than 6.8G.

At the B Line, the pouch-shaped battery cell 10 travels in a width-wise direction. At the end of the B Line, the pouch-shaped battery cell 10 is transferred to the Stacking line where the pouch-shaped battery cell 10 meets with the pouch-shaped battery cell 10 from the A Line and traveling along the Stacking Line. The pouch-shaped battery cell 10 from the B Line is stacked on the pouch-shaped battery cell 10 from the A Line, and the stacked pouch-shaped battery cells both travel on the Stacking Line in the length-wise direction. The Stacking Line is configured to move the stacked pouch-shaped battery cells in a speed boundary of below 7G, and preferably in a speed range greater than zero and up to 526mm/sec range or 610mm/sec. Alternatively, the Stacking Line is configured to move the stacked pouch-shaped battery cells such that the maximum impact value that the lead terminal tabs of the stacked pouch-shaped battery cells encounter is no more than 6.8G.

At the C Line, the pouch-shaped battery cell 10 travels in a width-wise direction. At the end of the C Line, the pouch-shaped battery cell 10 is transferred to the Stacking line where the pouch-shaped battery cell meets with the stacked pouch-shaped battery cells from the A Line and the B Line, and traveling along the Stacking Line. The pouch-shaped battery cell 10 from the C Line is stacked on the stacked pouch-shaped battery cells, and the three stacked pouch-shaped battery cells travel on the Stacking Line in the length-wise direction. The C line is configured to move the stacked pouch-shaped battery cells in a speed boundary of below 7G, and preferably in a speed range greater than zero and up to 526mm/sec or 610mm/sec. Alternatively, the C Line is configured to move the stacked pouch-shaped battery cells such that the maximum impact value that the lead terminal tabs of the stacked pouch-shaped battery cells encounters is no more than 6.8G. Subsequently, the three stacked pouch-shaped battery cells are bound to each other.

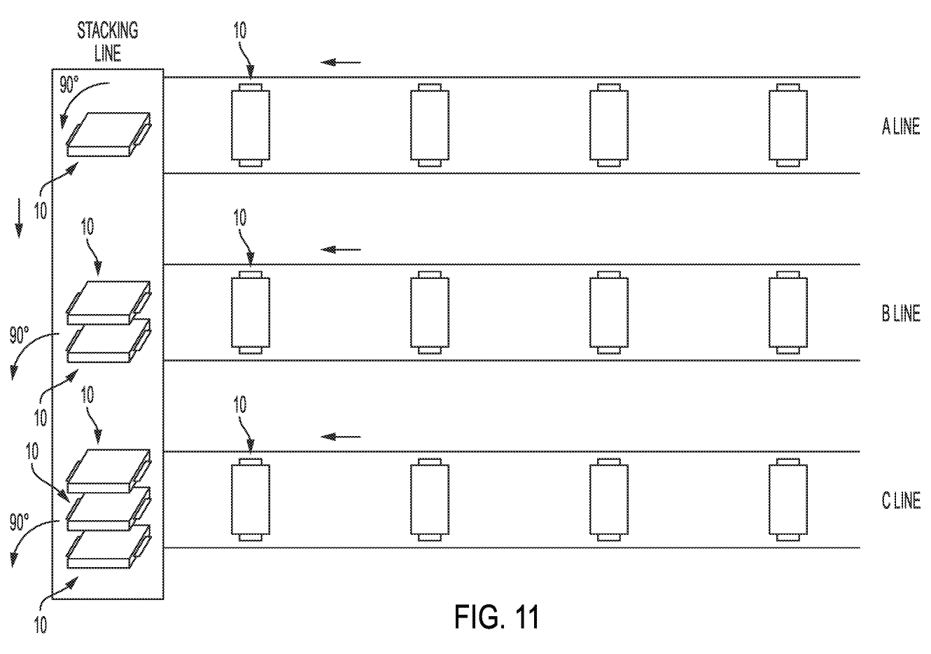

FIG. 11 is a diagram illustrating pouch-shaped battery cells 10 moving in productions lines according to yet another embodiment of the present disclosure. Referring to FIG. 11, the production lines comprise transfer lines A Line, B Line, C Line, and Stacking Line. A pouch-shaped battery cell 10 traveling in the A Line is transferred to the Stacking line. The A Line moves the pouch-shaped battery cell 10 in a width-wise direction. At the end of the A Line, the pouch-shaped battery cell 10 is transferred to the Stacking Line where the pouch-shaped battery cell 10 is rotated by 90 degrees. The pouch-shaped battery cell 10 may be rotated by a turntable. Turntables in a production line is well known and will not be further described. The pouch-shaped battery 10 then travels along the Stacking Line in the width-wise direction.

At the B Line, the pouch-shaped battery cell 10 travels in a width-wise direction. At the end of the B Line, the pouch-shaped battery cell 10 is transferred to the Stacking line where the pouch-shaped battery cell 10 is rotated by 90 degrees, for example, by a turntable, and meets with the pouch-shaped battery cell 10 from the A Line and traveling along the Stacking Line. The pouch-shaped battery cell 10 from the B Line is stacked on the pouch-shaped battery cell 10 from the A Line, and the stacked pouch-shaped battery cells both travel on the Stacking Line in the width-wise direction.

At the C Line, the pouch-shaped battery cell 10 travels in a width-wise direction. At the end of the C Line, the pouch-shaped battery cell 10 is transferred to the Stacking line where the pouch-shaped battery cell is rotated by 90 degrees, for example, by a turntable, and meets with the stacked pouch-shaped battery cells from the A Line and the B Line, and traveling along the Stacking Line. The pouch-shaped battery cell 10 from the C Line is stacked on the stacked pouch-shaped battery cells, and the three stacked pouch-shaped battery cells travel on the Stacking Line in the width-wise direction. Subsequently, the three stacked pouch-shaped battery cells are bound to each other.

The present disclosure has been described above in more detail through the drawings and examples. Although the present disclosure has been described based on preferred embodiments with reference to the accompanying drawings, those skilled in the art will clearly understand that various and obvious modifications are possible without departing from the scope of the present disclosure. Therefore, the scope of the present disclosure should be construed by the appended claims to include the various modifications.

What is claimed is:

1. A method of preventing separator slip in a battery cell that is stopped by a stopper in a production line, the method comprising:
transporting the battery cell in a length-wise direction at the production line such that terminal tabs of the battery cell are parallel to a moving direction of the production line; and
controlling an acceleration of the battery cell to move on the production line to less than 7G such that the separator slip is prevented in an impact between the battery cell and the stopper.

2. The method of claim 1, further comprises controlling the acceleration of the battery cell to move on the production line to no more than 6.8G.

3. The method of claim 1, further comprises controlling a speed of the battery cell such that the speed does not exceed 610mm/sec at impact with the stopper.

4. The method of claim 1, further comprises controlling a speed of the battery cell such that the speed does not exceed 526mm/sec at impact with the stopper.

5. The method of claim 1, wherein in transferring the battery cell to another production line, the method comprises transporting the battery cell in a width-wise direction at the another production line such that terminal tabs of the battery cell are orthogonal to a moving direction of the another production line.

6. A method of preventing separator slip in a battery cell that is stopped by a stopper in a production line, the method comprising:
transporting the battery cell in a width-wise direction at the production line such that terminal tabs of the battery cell are orthogonal to a moving direction of the production line;
transferring the battery cell to another production line such that the battery cell travels in a length-wise direction in which the terminal tabs of the battery cell are parallel to a moving direction of the another production line; and
controlling an acceleration of the battery cell to move on the another production line to less than 7G such that the separator slip is prevented in an impact between the battery cell and the stopper.

7. The method of claim 6, further comprises controlling the acceleration of the battery cell to move on the another production line to no more than 6.8G.

8. The method of claim 6, further comprises controlling a speed of the battery cell traveling at the another production line such that the speed does not exceed 610mm/sec at impact with the stopper.

9. The method of claim 6, further comprises controlling a speed of the battery cell traveling at the another production line such that the speed does not exceed 526mm/sec at impact with the stopper.

10. A method of preventing separator slip in a battery cell that is stopped by a stopper in a production line, the method comprising:
transporting the battery cell in a width-wise direction at the production line such that terminal tabs of the battery cell are orthogonal to a moving direction of the production line; and
transferring the battery cell to another production line such that the battery cell travels in the width-wise direction in which the terminal tabs of the battery cell are orthogonal to a moving direction of the another production line.

11. The method of claim 10, further comprises rotating the battery cell at transfer to another production line such that the battery cell travels in the width-wise direction.

12. The method of claim 10, wherein the another production line is orthogonal to the production line, the method further comprises rotating the battery cell 90 degrees at transfer to the another production line such that the battery cell travels in the width-wise direction at the another production line.
